(19) United States
(12) Patent Application Publication
(10) Pub. No.: US 2009/0004591 A1
(43) Pub. Date: Jan. 1, 2009

(54) ELECTROSTATIC IMAGE DEVELOPING TONER AND METHOD FOR PRODUCING THE SAME

(75) Inventors: Tsuyoshi UCHIDA, Tokyo (JP); Masahiro ANNO, Tokyo (JP); Yukio HOSOYA, Tokyo (JP); Masaharu SHIRAISHI, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/043,446

(22) Filed: Mar. 6, 2008

(30) Foreign Application Priority Data
Jun. 29, 2007 (JP) 2007171902

(51) Int. Cl. G03G 9/087

(52) U.S. Cl. 430/110.4; 430/137.14

(57) ABSTRACT

Disclosed is a toner for developing electrostatic image containing toner particles prepared with a method containing a step of: coagulating resin particle A, resin particle B and a colorant, wherein resin particle A and resin particle B respectively have volume average particle diameters Dₐ and D_{b} which are different in value from each other; and Dₐ and D_{b} satisfy the following relationship: 0.05≦D_{b}/Dₐ≦0.7.

This application is based on Japanese Patent Application No. 2007-171902 filed on Jun. 29, 2007 with Japan Patent Office, the entire content of which is hereby incorporated by reference.

### TECHNICAL FIELD

The present invention relates to an electrostatic image developing toner (hereinafter also referred to as a toner) employed for electrophotographic image formation, and a method for producing the same.

### BACKGROUND

It may be stated that development of electrophotographic image forming devices, represented by copying machines and printers, is in a striking situation, while receiving a following wind of the progress of IT (information technologies) and office automation. For example, when attention is paid to image forming devices for office use, machine types called composite machines MFP (also known as multifunction peripherals) have appeared, whereby it has become possible to respond to a variety of needs employing a single image forming device.

Further, in response to demands such as enhanced outputted images, formation of color images and an increase in the production rate of images, high-speed printers have emerged which enable formation of high precision images and full-color images, whereby it has been possible to conveniently provide impressive full-color business documents including photograph images and conference handouts. For example, printers capable of forming full-color images, exemplified by the tandem method, are designed to meet various printing needs by carrying colored toners such as yellow, magenta and cyan in addition to black toners (refer, for example, to Patent Document 1). As noted above, it may be stated that image forming devices in recent years have greatly contributed to the improvement of business office activities.

Typical prints prepared by the above image forming devices include, for example, photographic images, posters, materials for presentations, design materials, OHP (Over Head Projector) prints, and reports. As images become more highly detailed and more full-colored, a toner coverage becomes higher whereby the amount of used toner increases. On the other hand, prints such as reports only carrying text are composed of images of a lower toner coverage compared to prints of highly detailed and full-color images. As noted above, since the types and/or amounts of toners employed for producing prints fluctuate depending on prints, there exist, in the business world, printers having such a using pattern which employs extremely large amounts of specific toners compared to other toners.

In image forming devices in which the employed amount of toners varies depending on the types of toners, since a toner of employed large amount passes through in a large amount due to increased amount of replenished toner, so that loaded toner does not remain in the development device for an extended period, and thus there is little concern that the loaded toner is continuously agitated in the development device. On the other hand, with regard to a small amount of employed toner, the frequency of replenishment decreases, whereby the duration of the toner remaining in the development device increases, and the loaded toner is continuously agitated, resulting in concern of toner degradation due to stress by the agitation.

Specifically, in order to maintain and enhance the electrification properties and fluidity of toners, external additives, represented by inorganic metal oxides, are added onto the toner particle surface. When the toner is subjected to continuous stress due to such as agitation, problems will occur in which external additives are isolated from the toner or buried into the same toner. The isolated external additives adhere to charging members, development rollers, or carriers, to result in staining of these members, whereby the toner can not be sufficiently charged during image formation. Further, the toner to which external additives are buried is subjected to degradation of fluidity and electrification properties, whereby the image forming capability which is targeted at a designing stage can not be realized. As noted above, due to staining by isolated external additives or burying of external additives, electrostatic charging of toner is not sufficiently conducted during image formation. Further, since toners of degraded capability are employed, problems occur such as inferior images such as fog and low density and scattering of the toner.

On the other hand, development of the toner which exhibits stress resistance and high physical durability has been studied. For example, in a toner in which colored particles, which become a matrix, are prepared via coalescent process, a technology is disclosed which realizes high physical durability of the toner by regulating the particle diameter or the degree of cross-linking of resin particles employed as a raw material (refer, for example, to Patent Document 2).

(Patent Document 1) Japanese Patent Application Publication (hereinafter referred to as JP-A) No. 10-20598

(Patent Document 2) JP-A No. 2004-163612

### SUMMARY

However, the technologies disclosed in the above patent documents were developed to improve physical durability of colored particles themselves which are toner matrixes. Further, the above patent documents do not disclose designing of colored particles so that external additives added onto the surface of toners are neither isolated nor buried due to stress. Consequently, it was not verified that the toner prepared by the technologies disclosed in the above patent documents are capable of forming stable images without degradation of performance of external additives even after being subjected to stress.

As noted above, the development of a toner has been demanded which is capable of exhibiting specified electrification properties and fluidity without degrading the performance of external additives which are added onto the toner surface when the toner is placed under stress over an extended period of time. An object of the invention is to provide an electrostatic image developing toner which is capable of consistently exhibiting specified electrification properties and fluidity without isolation of the external additives from toners or burying thereof in toners even when the toners remain under such a severe image-forming environment that the toners are continuously agitated in a developing device over an extended period of time. Namely, an object of the invention is to provide an electrostatic image developing toner which is capable of providing consistent reproducibility of fine lines without localized image inferiority on paper such as density unevenness and fog and so-called uneven distribution/drop out, even when images are formed employing toners which have been under stresses for an extended period of time. Further, another object of the invention is to provide an electrostatic image developing toner which exhibits excellent fluidity so that the toner does not result in mutual adhesion, so called packing phenomenon, even when the toner is allowed to stand after having been under stress over an extended period of time.

The inventors of the invention discovered that the above problems were solved by any of embodiments described below.

1. One of the embodiments of the present invention is a toner for developing electrostatic image comprising toner particles prepared with a method containing a step of:

coagulating resin particle A, resin particle B and a colorant,

wherein resin particle A and resin particle B respectively have volume average particle diameters Dₐ and D_{b} which are different in value from each other; and

Dₐ and D_{b} satisfy the following relationship:

0.05≦D_{b}/Dₐ≦0.07.

2. Another embodiment of the present invention is a toner,

wherein the volume average particle diameter D_{b} of resin particle B is from 7.5 to 200 nm, and a weight average molecular weight of resin particle B is from 20,000 to 200,000 measured with gel permeation chromatography.

3. Another embodiment of the present invention is a method of forming a toner for developing electrostatic image comprising a step of;

coagulating resin particle A, resin particle B and the colorant,

wherein resin particle A and resin particle B respectively have volume average particle diameters Dₐ and D_{b} which are different in value from each other; and

Dₐ and D_{b} satisfy the following relationship:

0.05≦D_{b}/Dₐ≦0.7.

4. Another embodiment of the present invention is a method of forming a toner for developing electrostatic image,

wherein the volume average particle diameter D_{b} of resin particle B is from 7.5 to 200 nm, and a weight average molecular weight of resin particle B is from 20,000 to 200,000 measured with gel permeation chromatography.

According to the invention, for example, even when images are formed by employing a toner which has been placed under such a severe environment that the toner remain under agitation in the developing device for an extended period of time, external additives which were added onto the toner surface are neither isolated from the toner nor buried in the toner. Accordingly, external additives are retained on the toner particle surface even when remains under stress in the developing device, whereby desired fluidity and electrification properties due to external additives are provided to the toner. As a result, even if a toner which has been stirred in the development device over an extended period of time is employed, excellent toner images without image problems such as fog and a decrease in density can be realized, and further, it has become possible to form images without staining of the interior of the device due to toner scattering.

### BRIEF DESCRIPTION OF THE DRAWINGS

FIG. 1 is a cross-sectional view of a usable developing device loaded with the toner according to the invention.

FIG. 2 is a cross-sectional view of another example of a developing device loaded with a non-magnetic single component developer.

FIG. 3 is a cross-sectional view of an image forming apparatus on which the developing device of FIG. 1 can be mounted.

FIG. 4 is a cross-sectional view of the tandem type full-color image forming apparatus.

### DESCRIPTION OF THE PREFERRED EMBODIMENTS

With regard to the toner according to the invention, its physical durability is enhanced in such a manner that, for example, when placed in a circumstance such as continuous agitation in a developing device over an extended period of time, external additives added onto the toner particle surface are neither isolated nor buried due to effect of stress, so that it becomes possible to provide a toner with predetermined electrification properties and fluidity.

For example, during image formation employing a non-magnetic single component developing system, a toner is agitated in the developing device when the toner is tribo-electrically charged during the developing process, and thereafter, a thin film of the toner is formed on the developing roller. During these processes, the toner is subjected to continuous and strong impact, and the resulting stress occasionally causes problems in which external additives which are added onto toner surfaces are isolated or buried in the toner. Specifically, in a full-color image forming device, the toner, which is not used as frequently, tends to stay for a longer period in the developing device due to fewer chances of toner replenishment into the developing device to result in receiving the agitation at the image formation all the time. In view of the foregoing, a toner has been desired that, even when the toner remains under an environment of receiving stress over an extended period of time, the toner allows external additives to sufficiently exhibit functions of added external additives without the external additives which are added onto the toner particle surface being isolated or buried in toners.

The inventors of the invention discovered that the problems of the invention were solved by coagulating two types of resin particles which are in a specific relationship of a volume average particle diameter while producing the colored particles constituting the toner, that is, particles constituting toner matrixes prior to the addition of external additives. Namely, it was discovered that with regard to the toner formed by coagulation of colored particles and two types of resin particles, in which the volume average particle diameters of the above resin particles were at a specific relationship, the external additives on surfaces of the toner were neither isolated nor buried even when the toner remained under an environment in the interior of the developing device where the toner was subjected to stress over an extended period of time.

The present invention will be detailed.

The toner according to the invention is produced via a step which forms colored particles (which refer to particles constituting toner matrixes prior to the addition of external additives) by coagulating two types of resin particles A and B differing in volume average particle diameter. Further the toner of the invention holds the following relationship.

0.05≦D_{b}/Dₐ≦0.7

wherein Dₐ represents the volume average particle diameter of resin particles A, and D_{b} represents the volume average particle diameter of resin particles B. As noted above, the toner according to the invention is prepared in such a manner that colored particles are formed by coagulating two types of resin particles differing in volume average particle diameter, after which external additives are added onto the surface of the colored particles formed by coagulating resin particles.

As mentioned above, the toner according to the invention is prepared via a step of coagulating two types of resin particles which satisfy the relations of volume average particle diameters described above, and results in neither isolation nor burying of the external additives even when the toner is placed under an circumstance affected by continuous stress such as in the interior of a developing device.

It is assumed that when colored particles are formed of coagulated resin particles, spaces are formed among the coagulated particles. Minute resin particles enter into the resulting spaces and resin's capability of packing in colored particles is increased to enhance physical strength. As a result, it is assumed that external additives can not be buried in a particle even when the toner is subjected to continuous agitation under stress.

Further, minute irregularities are formed on the surface of colored particles formed by coagulating resin particles, and when external additives are added in the presence of such irregularity, individual external additives are less able to adhere firmly to the surface of the colored particle due to reduced contact area of the external additives and colored particles. In the present invention, it is assumed that the smoothness of the surface of the colored particle increases due to inclusion of minute resin particles in concave portions, and the adhesion strength of the external additives increases due to an increase in the contacting area between the external additives and the colored particles. As a result, it is further assumed that external additives are not isolated from surface of the toner even when the toner is subjected to continuous agitation under stress.

Yet further as noted above, in the present invention, it is assumed that by coagulating resin particles employing smaller resin particles, the physical strength and the surface characteristic (smoothness) of colored particles are enhanced, and as a result, external additives are neither buried in the toner nor isolated from the surfaces of the toner particles. Namely, when the value of D_{b}/Dₐ, where Dₐ represents volume average particle diameter of resin particles A, and D_{b} represents volume average particle diameter of resin particles B, is in the above range, it is assumed that circumstance is formed so that resin particles B are optimally buried in the spaces existing among particles, whereby the physical strength and the surface smoothness of colored particles are enhanced.

On the other hand, when the value of D_{b}/Dₐ is at most 0.05, it is assumed that since resin particles B are extremely small compared to resin particles A, it becomes difficult to fill the surface cavities during the coagulation process, whereby it becomes less likely to enhance the physical strength of colored particles since the space in the colored particles is not completely filled. It is still further assumed that if cavities remain on the surfaces of the colored particle, surface smoothness is not enhanced, whereby it is not possible to secure optimal adhesion of the external additives to the surface of the colored particle.

When value D_{b}/Dₐ is at least 0.7, it is assumed that since resin particles B are much larger, it is difficult for them to enter the irregular cavities among the colored particles to result in the residual voids, whereby it also becomes difficult to enhance physical strength of the colored particles. Further, it is assumed that since it is difficult to fill concave portions on the surface of the colored particle, the surface smoothness of the colored particle decreases, resulting in decreased adhesion of the external additives.

It is possible to determine the volume average particle diameter of resin particles A and B employed in the toner according to the invention which are provided in a state where each resin particle is dispersed in an aqueous surface active agent solution. In such a case, listed are, for example, measuring methods employing a particle size analyzer utilizing dynamic light scattering such as a dynamic light scattering type NANOTRACK particle size distribution meter “MICROTRACK UPA150” (produced by Microtrack Co.).

Measuring steps of determination employing “MICROTRACK UPA150” will be described. The following measuring parameters are to be set via machine control programs, “MICROTRACK UPA150”. (1) measuring conditions

Sample refractive index: 1.59, sample specific gravity: 1.05, sphere particle equivalent

solvent refractive index: 1.33, solvent viscosity: 0.797 (30° C.), 1.002 (20° C.)

(2) Pure water is placed in a measurement cell followed by zero-point adjustment. (3) Into 50 ml of pure water, 1 ml of a 20% dispersion of resin particles A or resin particles B is added. Herein, the 20% dispersion is prepared by dispersing resin particles into pure water. (4) The prepared dispersion is subjected to ultrasonic treatment for about three minutes, whereby coagulation of resin particles due to solvent shocks is eliminated. (5) The dispersion after ultrasonic treatment is then transferred to a measuring cell, and the transmission density is confirmed to be within the appropriate range (0.1-10.0 in terms of intensity). (6) After the transmission density is confirmed to be within the appropriate range, a measurement is started by the machine's control program. When the transmission density is not within the appropriate range, the transmission density is adjusted to be within the appropriate range by adding additional pure water, which lowers the ratio of the toner.

Determination duration was set to 180 seconds and determination frequency was set to a single time. Volume average particle diameter M was calculated via the following formula.

Volume average particle diameter M=Σ(vi·di)/Σ(vi). Further, in the present invention, with regard to resin particles B, it is preferable that the weight average molecular weight is regulated to be 20,000-200,000, while the volume average particle diameter D_{b} is 7.5-200 nm. As noted above, by specifying volume average particle diameter D_{b} and the weight average molecular weight of resin particles B to be in the specific ranges as described above, resin particles B are allowed to be in an uniformly dispersed state in an aqueous medium and are allowed to coagulate with resin particles A and colored particles. As a result, it is assumed that resin particles B are uniformly adhered to resin particles A and the colored particles, whereby resin particles B effectively and surely fill spaces and concave portions of the surface of the colored particle, whereby physical strength and surface smoothness of the colored particles are assured to increase.

The weight average molecular weight of resin particles B is determined by gel permeation chromatography (hereinafter also referred to as the GPC method). Steps to determine the weight average molecular weight via the gel permeation chromatography are described below.

First, resin particles B are dissolved in tetrahydrofuran to a density of 1 mg/ml. Dissolution is carried out at room temperature over five minutes, employing an ultrasonic homogenizer. Subsequently, the resulting solution is forced through membrane filters of a pore size or 0.2 μm followed by injection of 10 μl of the sample solution into the measuring apparatus described below.

Measuring conditions of the gel permeation chromatography are cited below.

Apparatus: HLC-8220 (produced by Tosoh Corp.)

Column: a triple column of TSKguardcolumn+TSKgelSuperHZM-M (produced by Tosoh Corp.)

Column temperature: 40° C.

Flow rate: 0.2 ml/minute

Detector: refractive index (RI) detector

With regard to measurement of the weight average molecular weight of resin particles B, the molecular weight distribution of the sample is calculated employing a calibration curve measured employing monodispersed polystyrene standard particles. Ten polystyrenes are used for the determination of the calibration curve.

Subsequently, softening points which are suitable for the toner of the invention will be described. With regard to toners according to the invention, the softening point is preferably regulated within the range of 105-125° C., and more preferably regulated within the range of 110-120° C. By regulating the softening point of the toner to be 105-125° C., the aforesaid low-temperature fixing characteristic is realized. Further, the toner does not cause even an occurrence of undesired gloss of toner images, so-called shininess. Therefore, especially when text images are formed, they are easy on the eyes.

As methods to regulate the softening point of the toner, exemplified methods are described below. Namely, listed are (1) a method to control the types of monomers composing resins employed in formation of specific resin particles, and composition ratios of monomers in copolymers, (2) a method to regulate the degree of polymerization by controlling the amounts of polymerization initiators and chain transfer agents, and (3) a method to control the types and amounts of fixing aids such as waxes (a mold-release agent) which are added to toners. By combinations of these methods, a toner of a targeted softening point can be prepared.

For example, when resins constituting the toner are composed of copolymers, as stated above, the softening point of the toner by controlling the composition ratio of polymerizable monomers of resin components can be controlled. Namely, of polymerizable monomers composing the resins, by increasing the ratio of the polymerizable monomers which exhibit a high glass transition temperature or a softening point, when the monomers are formed as homopolymer, the softening point can be designed to be relatively high. Further, of polymerizable monomers composing the resins, by increasing the ratio of the polymerizable monomers which exhibit a low glass transition temperature or a softening point when the monomers are formed as homopolymer, the softening point can be designed to be relatively low.

Further, the softening point can be regulated by controlling polymerization conditions while producing the resin. Namely, it is possible to design the softening point to be higher as the molecular weight of the resin is increased, and on the contrary, it is possible to design the softening point to be lower as the molecular weight of the resin is decreased. For example, the molecular weight of the resin can be increased by decreasing the added amount of polymerization initiators or chain transfer agents, or by increasing the polymerization duration. On the contrary, the molecular weight of the resin can be decreased by increasing the added amount of the polymerization initiators or chain transfer agents, or by decreasing the polymerization duration.

A method of measuring the softening point of a toner follows. Specifically, “FLOW TESTER CFT-500” (produced by Shimadzu Corp.) is used. A column of toner is formed to a height of 10 mm, and a load of 200 kPa is applied to it employing a plunger, heated at a temperature increase rate of 6° C./minute so that the toner is allowed to be extruded, whereby a curve (a softening fluid curve) between the plunger's descent amount and temperature of the above flow tester is plotted, and the initial outflow temperature is designated as a melt initiating point, while the temperature for a descent of 5 mm is designated as the softening point.

Production methods of the toner according to the invention will be described.

Colored particles (which are matrix particles prior to the external additives treatment) which constitute the toner according to the invention are composed of at least a resin and a colorant. The production methods of the toner according to the invention are not particularly limited, but in view of reproduction of micro dot images, a method is preferred which is capable of producing small diameter toners, for example, such as the particle diameter of 3-8 μm in terms of 50% volume based particle diameter (D50). It is preferable that the small diameter toner is produced via a polymerization method which enables formation of particles with additional operations to regulate particle diameter and shape during the production process. Of the above methods, a so-called emulsion coalescence method is an especially effective method, in which specified resin particles of about 100 nm are formed in advance via an emulsion polymerization method or a suspension polymerization method, and then, through a coagulation step of the specific sized resin particles, colored particles of the above particle diameter are formed.

Production method of the toner via an emulsion coalescing method, as an example of production methods of the toner according to the invention, is described below. The toner production via an emulsion coalescing method is carried out via a process comprising the steps listed below.

(1) a step of producing a dispersion of resin particles

(2) a step of producing a dispersion of coloring agent particles

(3) a coagulation/fusion step of resin particles

(4) a ripening step

(5) a cooling step

(6) a washing step

(7) a drying step

(8) a step of external additive treatment

Each of the above steps is detailed below.

(1) A Step of Producing a Dispersion of Resin Particles

This step forms resin particles having about 100 nm in diameter, in such a manner that a polymerizable monomer which forms resin particles A or resin particles B is placed into an aqueous medium. It is also possible to form resin particles incorporating a wax therein, in which case, resin particles incorporating a wax are formed in such a manner that waxes are dissolved or dispersed in a polymerizable monomer, and the resulting monomer is polymerized in an aqueous medium.

(2) A Step of Producing a Dispersion of Coloring Agent Particles

This is a step of dispersing a coloring agent in an aqueous medium to produce a dispersion of coloring agent particles having a particle size of approximately 110 nm.

(3) A Coagulation/Fusion Step of Resin Particles

This is a step of producing colored particles by coagulating resin particles A and B, and coloring agent particles in such a manner that the above particles are coagulated in an aqueous medium in the presence of a multivalent metal salt, after which the resulting coagulated particles are fused. This step corresponds to the so-called “a coagulation step of resin particles”.

In this step, coagulants such as alkali metal salts and alkaline earth metal salts, represented by magnesium chloride, are added to an aqueous medium in which resin particles A and B, and coloring agent particles are present. Subsequently, by heating the above reacted components to a temperature of at least the glass transition point of the aforesaid resins A and B, and to at least the melting peak temperature of the aforesaid mixture, coagulation of the particles is then allowed to proceed, whereby the fusion among resin particles is concurrently carried out.

Coagulation is allowed to proceed further, and when the particles reach the targeted size, the coagulation is terminated by adding salts, such as common table salt.

In this invention, coagulation is carried out via the above step by adding resin particles B in addition to resin particles A and coloring agent particles. The addition of resin particles B, as described above, strengthens coagulation interfaces between the resin particles and the coloring agent particles, resulting in greater physical durability and excellent adhesion property of external additives.

(4) A Ripening Step

This step, following the foregoing coagulation/fusion step, is to allow ripening of the colored particles by heating the reacted components until the coloring particles reach the targeted average circularity.

Further, in this invention, after formation of particles incorporating resins and a coloring agent, it is also possible to form colored particles having the so-called core/shell structure which is formed by covering the exterior of the above particles with additional resins. Specifically, initially, colored particles which will become the core (hereinafter referred to as core particles) are produced via the aforesaid coagulation/fusion and ripening steps by association and fusion of resin particles A, coloring agent particles and resin particles B which were formed by employing a polymerizable monomer having a polar group in the side chain, as represented by acrylic acid. Subsequently, resin particles, to form a shell, are added to a core particle dispersion to allow the resin particles to coagulate and fuse onto and cover the core particle surface, whereby colored particles having a core/shell structure are produced.

In such a case, a structure exhibiting no exposure of any part of the core to the toner surface can be formed by allowing shell forming resins to adhere uniformly to the surface of the core particles. It is assumed that the above structure is realized via formation in an environment in which no electric unevenness is allowed to exist on the surface of the core particles, where dispersibility of coloring agent particles included in the core particles is enhanced, due to formation of core particles by employing resin particles B which are formed from monomers having polar groups. As a result, it is assumed that the resin particles for the shell formation are allowed to adhere over the entire surface of the core particles with identical probability to result in such perfect shelling that no portions of core particles is exposed.

(5) A Cooling Step

This step is a cooling treatment process (a rapid cooling treatment) of a dispersion of the above colored particles. The cooling rate as a condition of the rapid cooling treatment is in the range of 1-20° C./min. Examples of cooling treatment methods may include, but not limited to, a cooling method by externally charging a refrigerant into a reaction vessel or a cooling method of introducing cold water directly into the reaction system.

(6) A Washing Step

This step is composed of solid-liquid separation of colored particles from the colored particle dispersion which was cooled down to the prescribed temperature in the above step and washing so that adhered components such as surfactants or coagulants are removed from the colored particles which were subjected to the solid-liquid separation treatment resulting into a coagulated cake, a so-called wet toner cake.

The washing treatment is carried out with water until the filtrate reaches a specific electric conductivity, for example, about 10 μS/cm. Filtration methods include, but are not limited to, a centrifuge separation method, a filtration method under reduced pressure employing a Nutsche filter, or a filtration method employing a filter press.

(7) A Drying Step

This step is to prepare dried colored particles by drying treatment of the colored particles which were subjected to the above washing treatment. Driers employed in this step include a spray drier, a vacuum freeze drier, or a reduced-pressure drier. However a standing rack drier, a moving rack drier, a fluidized-bed drier, a rotary drier, or a stirring drier are preferred.

The moisture content of the dried colored particles is preferably at most 5% by mass, and more preferably at most 2% by mass. If dried colored particles are coagulated due to weak attraction force, the coagulate may be subjected to a disintegration treatment, via a mechanical disintegrating apparatus such as a jet-mill, a Henschel mixer, a coffee mill, and a food processor.

(8) A Step of External Additive Treatment

This step adds inorganic particulates or organic particulates having a number-average primary particulate size of from 4 to 800 nm as an external additive to the dried colored particles to form a toner. As a mixing means of the external additives, cited are mechanical mixers such as a Henschel mixer and a coffee mill.

In this invention, when volume average particle diameters Dₐ and D_{b} of respective resin particles A and B constituting colored particles have the above-mentioned relationship, the external additives are neither buried in the toner surface nor isolated from the surface of the toner even when the toner is stored in an environment so that the toner is subjected to stress over an extended period of time.

Next, specific examples of resins, a coloring agent or a wax constituting the toner of the invention will be detailed.

Resins usable in a toner of the invention may employ polymers formed via polymerization of a polymerizable monomer, called vinyl monomers which are described below. Further, a polymer constituting resins usable in the invention, which is composed of a polymer obtained via polymerization of at least one type of polymerizable monomer, may be prepared by employing the vinyl monomers individually or in combinations thereof.

Specific examples of a polymerizable monomer are listed below.

### (1) Styrene or Styrene Derivatives:

styrene, o-methylstyrene, m-methylstyrene, p-methylstyrene, α-methylstyrene, p-chlorostyrene, 3,4-dichlorostyrene, p-phenylstyrene, p-ethylstyrene, 2,4-dimethylstyrene, p-t-butylstyrene, p-n-hexylstyrene, p-n-octylstyrene, p-n-nonylstyrene, p-n-decylstyrene, and p-n-dodecylstyrene;

### (2) Methacrylic Acid Ester Derivatives:

methyl methacrylate, ethyl methacrylate, n-butyl methacrylate, iso-propyl methacrylate, iso-butyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate;

### (3) Acrylic Acid Ester Derivatives:

methyl acrylate, ethyl acrylate, iso-propyl acrylate, n-butyl acrylate, t-butyl acrylate, iso-butyl acrylate, n-octyl acrylate, 2-ethylhexyl acrylate, stearyl acrylate, lauryl acrylate, and phenyl acrylate;

### (4) Olefins:

ethylene, propylene, and isobutylene;

### (5) Vinyl Esters:

vinyl propionate, vinyl acetate, and vinyl benzoate;

### (6) Vinyl Ethers:

vinyl methyl ether, and vinyl ethyl ether;

### (7) Vinyl Ketones:

vinyl methyl ketone, vinyl ethyl ketone, and vinyl hexyl ketone;

### (8) N-Vinyl Compounds:

N-vinyl carbazole, N-vinyl indole, and N-vinyl pyrrolidone;

### (9) Other Compounds:

vinyl compounds such as vinylnaphthalene and vinylpyridine; acrylic acid or methacrylic acid derivatives such as acrylonitrile, methacrylonitrile, and acrylamide.

In addition to the above, a toner of this invention may be formed, employing appropriately a polymerizable monomer having the above polar groups or a highly hydrophilic polymerizable monomer.

Further, also prepared may be cross-linked resins by employing poly-functional vinyls, of which specific examples of the poly-functional vinyls are listed below.

divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentylglycol dimethacrylate, and neopentylglycol diacrylate.

As a coloring agent usable for a toner of the invention, cited are known coloring agents, of which specific ones are listed below.

As a black coloring agent, usable examples are: carbon blacks such as furnace black, channel black, acetylene black, thermal black, and lampblack; as well as magnetic powders such as magnetite and ferrite.

Examples of coloring agents of magenta and red include: C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222.

Examples of coloring agents of orange and yellow include: C.I. Pigment Orange 3, C.I. Pigment Orange 43, C.I. Pigment Yellow 12, C.I. Pigment Yellow 13, C.I. Pigment Yellow 14, C.I. Pigment Yellow 15, C.I. Pigment Yellow 17, C.I. Pigment Yellow 93, C.I. Pigment Yellow 94, and C.I. Pigment Yellow 138.

Examples of coloring agents of green and cyan include: C.I. Pigment Blue 15 C.I. Pigment Blue 15:2, C.I. Pigment Blue 15:3, C.I. Pigment Blue 15:4, C.I. Pigment Blue 16, C.I. Pigment Blue 60, C.I. Pigment Blue 62, C.I. Pigment Blue 66, and C.I. Pigment Green 7.

The foregoing coloring agents may be used individually or in combinations of at least two of them. The amount of the coloring agent to be added is preferably set in the range of 1-30%, and more preferably in the range of 2-20% by mass of the total toner.

As a wax usable in the toner of the invention, known waxes are listed:

### (1) Polyolefin Wax:

polyolefin wax, and polypropylene wax

### (2) Long Chain Hydrocarbon Wax:

paraffin wax, and sasol wax

### (3) Dialkylketone Type Wax:

distearylketone

### (4) Ester Type Wax:

carnauba wax, montan wax, trimethylolpropane tribehenate, pentaerythritol tetramyristate, pentaerythritol tetrastearate, pentaerythritol tetrabehenate, pentaerythritol diacetate dibehenate, glycerin tribehenate, 1,18-octadecanediol distearate, trimellitic acid tristearate, and distearyl maleate

### (5) Amide Tye Wax:

ethylenediamine dibehenylamide, and trimellitic acid tristearylamid.

The melting point of a wax is typically 40-125° C., preferably 50-120° C., and more preferably 60-90° C. A melting point falling within the above range ensures heat stability of the toner, and simultaneously achieves stable toner image formation without cold offsetting even when fixing is carried out at low temperature. The wax content of the toner is preferably 1-30% by mass, and more preferably 5-20% by mass.

As a toner of this invention, a toner may be produced by adding, in the production step, particles such as inorganic particulates or organic particulates having a number-average primary particle size of 4-800 nm. Such particles are added as external additives.

The addition of such external additives improves fluidity or an electrification property of a toner, and achieves enhanced cleaning property. Specifically, in this invention, formation of colored particles, by employing particles A and B having the above-mentioned relationship of a volume-average particle diameter, inhibits burying of external additives in the toner particle surface or isolation of an external additive from the toner particle surface, even when a toner composed of the aforesaid colored particle receives continuous stress. Therefore, even when the toner is placed under severe image forming conditions, excellent toner images can be stably provided without affecting fluidity and an electrification property of a toner.

The type of external additives is not specifically limited and examples thereof include inorganic particulates, organic particulates, and lubricants, as listed below.

As inorganic particulates, commonly known ones are usable. Specifically, particulates such as silica, titania, alumina, and strontium titanate are preferably employed. Inorganic particulates may optionally be subjected to a hydrophobilization treatment. Specific examples of silica particulates include R-805, R-976, R-974, R-972, R-812, and R-809 which are commercially available from Nippon Aerosil Co., Ltd.; HVK-2150 and H-200 which are commercially available from Hoechst Co.; and TS-720, TS-530, TS-610, H-5, and MS-5 which are commercially available from Cabot Co.

Titania particulates include, for example, T-805 and T-604 which are commercially available from Nippon Aerosil Co. Ltd.; MT-100S, MT-100B, MT-500BS, MT-600, MT-600SS, and JA-1 which are commercially available from Teika Co.; TA-300SI, TA-500, TAF-130, TAF-510, and TAF-510T which are commercially available from Fuji Titan Co., Ltd.; and IT-S, IT-OA, IT-OB, and IT-OC which are commercially available from Idemitsu Kosan Co., Ltd.

Aluminum particulates include, for example, RFY-C and C-604 which are commercially available from Nippon Aerosil Co. Ltd.; and TTO-55 which is commercially available from Ishihara Sangyo Co., Ltd.

Further, as organic particulates, viable are spherical organic particulates having a number-average primary particle size of about 10-2,000 nm. Specifically, a homopolymer composed of styrene or methyl methacrylate, or a copolymer thereof may be employed.

To further enhance cleaning property or transferability, higher fatty acid metal salts, a so-called lubricant, are also usable as an external additive. Specific examples of such higher fatty acid metal salts include zinc, aluminum, copper, magnesium, and calcium stearate; zinc, manganese, iron, copper, and magnesium oleate; zinc, copper, magnesium, and calcium palmitate; zinc and calcium linolate; and zinc and calcium ricinolate.

The amount of such external additives is preferably 0.1-10.0% by mass of the total toner. The external additives may be added via various common mixers such as a turbuler mixer, a Henschel mixer, a nauter mixer, and V-shape mixer.

Since the toner of this invention does not result in burying or isolation of external additives, even when the toner is placed under such an environment that the toner is continuously stressed over an extended period of time, the toner is suitable for image formation by a non-magnetic single component development system, in which the toner is often stressed via agitation or formation of a thin layer. Specifically, during image formation via a single component development system, development is carried out in such a manner that a toner is electrically charged by being rubbed or pressed onto the surface of a charging member or a developing roller, after which the charged toner is fed onto an image bearing body by causing the charged toner to jump, therefore, the toner requires more physical durability due to more likelihood of stressing the toner. Further, image formation via a single component developing system in which the image is formed of a toner without a carrier, employing a developing apparatus having a fairly simple structure with less machine parts compared to an image forming apparatus of a two-component developing system. Thus, image formation via a single component developing system is effective for down-sizing the image forming apparatus. Specifically, the above developing system is effective in designing a full-color image forming apparatus in which individual development devices for yellow, magenta, cyan and black are arranged in a limited space.

The toner of the invention is also usable for an image forming toner for a two-component developing system, in which an electrostatic latent image on an image bearing body is developed via a carrier. Image formation via a two-component developing system is preferable for rapid image formation for reasons for example that the system can adopt a parallel arrangement structure of development devices which are difficult to be down-sized further as compared to an image forming device of a single component developing system. For example, when prints are prepared in a quantity of only several hundred in so-called on-demand printing, the advantage of high-speed printing is highly attractive for users such as people engaging in printing.

When the toner of the invention is employed as a two-component developer, the toner is constituted of a developer mixed with a carrier of magnetic particles. As a carrier, commercially known materials are usable. Examples thereof are metals such as iron, ferrite and magnetite, and alloys of the foregoing metals as well as aluminum and lead, of which ferrite particles are preferred. The volume average particle diameter of a carrier is preferably 15-100 μm and more preferably 25-80 μm.

Subsequently, described is an image forming method in which the toner of the invention is usable. As mentioned above, since the toner of the invention exhibits excellent physical durability, it is possible to employ a toner for image formation, in particular, by a non-magnetic single component system which is often stressed via agitation, or during formation of a thin layer during the development step.

An image forming method via a non-magnetic single component developing system is detailed below.

A developing apparatus (a development device), which is capable of image formation of the invention, is detailed below.

In the development step of a non-magnetic single component developing system, a toner which is borne on a development roller by a toner control member or a development roller by itself is charged to a prescribed level, after which the charged toner is fed to an image bearing member by causing the above toner to jump from the surface of the development roller. Thus, a development roller employed in image formation via a non-magnetic single component developing system requires properties such that the development roller does not inhibit jumping of the toner onto the image bearing member, in addition to the development roller securely charges the toner without losing the charge formed on the surface of the roller.

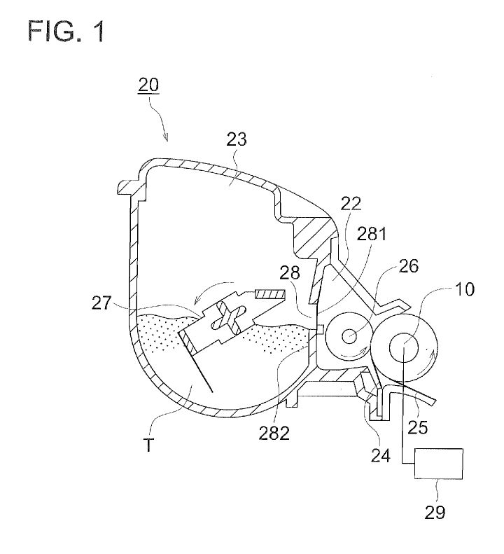

FIG. 1 is a cross-sectional view of development device 20 employable for an image forming method of the invention.

FIG. 1 is a cross-sectional view of development device of development employing a non-magnetic single component toner (a non-magnetic single component developer). Development device 20 is rotationally driven in the counterclockwise direction in the figure by a motor (not shown), and is composed of development roller 10, of this invention, which is in contact with or close vicinity to an image bearing body (not shown) with being incorporated in the image forming apparatus, buffer chamber 22 which is provided to the left of development roller 10, and hopper 23 which is adjacent to buffer chamber 22.

Development roller 10 is comprised of a conductive cylindrical substrate and on which an elastic layer of a hard material such as silicone rubber is formed on the periphery of the substrate.

Disposed in buffer chamber 22 is blade 24 serving as a toner controlling member with being pressed against development roller 10. Blade 24 controls the electrostatic charge and amount of toner applied onto development roller 10. Also provided may be auxiliary blade 25 to assist in control of the electrostatic charge and the amount of toner applied onto development roller 10, being downstream of blade 24 with respect to the direction of the rotation of development roller 10.

Developing roller 10 is pressed against feed roller 26, which is rotationally driven by a motor (not shown) in the same direction as development roller 10 (counterclockwise in the figure). Feed roller 26 is provided with an electrically conductive cylindrical substrate and a foamed layer of urethane foam or the like on the periphery of the substrate.

Hopper 23 houses toner T serving as a single-component developer, which is provided with rotor 27 to stir toner T. Rotor 27 is provided with a thin plate conveyance blade to convey toner T by rotation of rotor 27 in the arrowed direction. Toner T fed by the conveyance blade is fed into buffer chamber 22 through passage 28 provided in the wall separating hopper 23 from buffer chamber 22. The shape of the conveyance blade is formed so that the blade bends accompanying the rotation of rotor 27 while pushing the toner at the front in the rotation direction of the blade and returns to the straight state when reaching the left-side end of the passage 28. Thus, the blade feeds the toner to passage 28 by allowing its shape to be returned straight via the bent state.

Valve 281 is provided over passage 28 to close passage 28. The valve is a film-form member, one end of which is fixed at the upper right-hand side of passage 28 and when toner T is fed from hopper 23 into passage 28, the valve is pressed toward the right side by the pressure of toner T, to open passage 28. As a result, toner T is fed into buffer chamber 22.

Control member 282 is provided at the other end of valve 281. Control member 282 and feed roller 26 are so disposed that a slight opening is formed even when valve 281 closes passage 28. Control member 282 can be adjusted so that excessive toner does not accumulate at the bottom of buffer chamber 22. It is so controlled that toner T which is recovered to feed roller 26 from the development roller 10 can not fall in a large amount to the bottom of buffer chamber 22.

In development device 20, development roller 10 is rotationally driven in the arrowed direction during image formation, while toner in buffer chamber 22 is fed onto development roller 10 via rotation of feed roller 26. Toner T, fed onto development roller 10, is electrically charged and thin-layered by blade 24 and auxiliary blade 25, and is then conveyed to the region opposed to the image bearing body, whereby the electrostatic latent image on the image bearing body is subjected to image development. Any unused toner during development is returned to buffer chamber 22 via rotation of development roller 10 and is scraped off by feed roller 26 from development roller 10 for toner recovery.

In a development zone, a thin layer of toner on development roller 10 jumps from the peripheral surface of development roller 10 to form a powder-cloud due to action of the electric field formed by development bias voltage Vb and alternative voltage Vpp and applied by a development bias power supply apparatus (not shown). Next, a toner is fed onto electrostatic latent image bearing body 11 on which an electrostatic latent image is formed, whereby the electrostatic latent image is developed to form a toner image.

The thin toner layer formed on development roller 10 is controlled to a thickness of about 1.5 layers (about 1.5 particles of toner) when, for example, the circumferential speed of electrostatic latent image bearing body 11 and development roller 10 are set to be 100 mm/sec. and 200 mm/sec., respectively, and the force of toner control member 24 pressing against development roller 10 is set to 10-100 N/m.

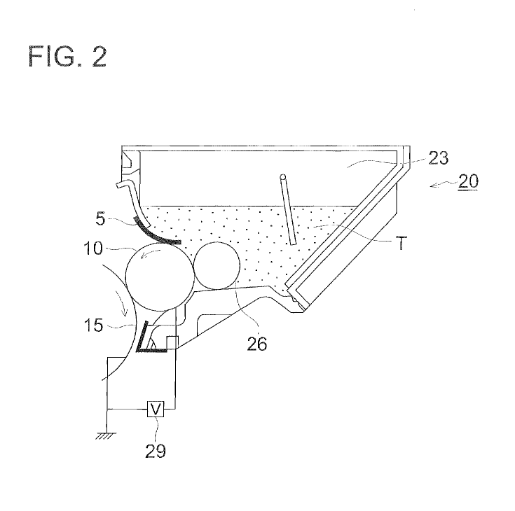

Another example of development device 20 housing a non-magnetic single developer is shown in FIG. 2, which device 20 in FIG. 2 can be mounted on the tandem type full-color image forming apparatus, which will be described below. In FIG. 2, numeral 20 denotes a development device housing a non-magnetic single developer of this invention, numeral 15 denotes a latent image bearing body (a photoreceptor drum), on which a latent image is formed by means of an electrostatic process or a means of electrostatic recording (not shown). Numeral 15 denotes a development roller composed of a non-magnetic sleeve made of aluminum or stainless steel as is development roller 10 shown in FIG. 1.

Toner T is stored in hopper 23, and is fed onto development roller 10 by feed roller 26, which is composed of foaming materials such as urethane foam in the same manner as a material employed for development device 20 of FIG. 1, and rotates in either the forward or reverse direction at a velocity relative to development roller 10 to remove any residual toner on the development roller as well as to feed toner. The toner fed onto development roller 10 is formed into a uniform thin layer by toner control member 24.

The constitution of a development device capable of image formation of this invention is not limited to those shown in FIG. 1 or FIG. 2.

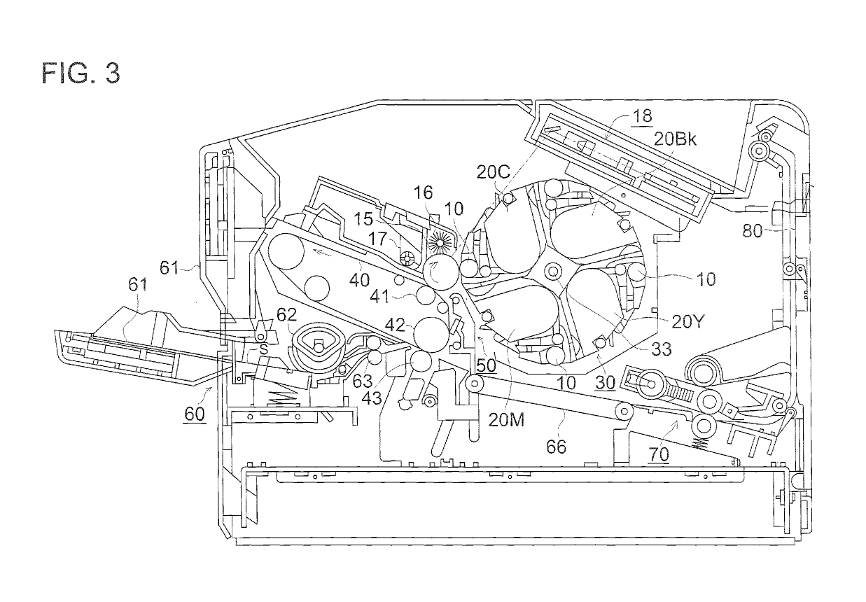

In FIG. 3, is drawn an example of a full-color image forming apparatus which can be installed into a development device of FIG. 1. Image forming apparatus 100 shown in FIG. 3 is a typical image forming apparatus which can be installed with the above developing device 20. In the image forming apparatus of FIG. 3, provided, around rotary-drivable electrostatic latent image bearing body 15, (hereinafter also referred to as photoreceptor drum 15), are electrostatic-charging brush 16 to allow the surface of photoreceptor drum 15 to be uniformly charged to a prescribed potential, and cleaner 17 to remove any residual toner on photoreceptor drum 15.

Laser scanning optical system 18 scanning-exposes the surface of photoreceptor drum 15, uniformly charged by charging brush 16 to form a latent image on photoreceptor drum 15. Laser scanning optical system 18 incorporates a laser diode, a polygon mirror and an fθ optical system, along with a control section whereby print data for each of yellow, magenta, cyan and black are transferred from a host computer. Based on the print data for the respective colors, laser beams are successively outputted to scan the surface of photoreceptor drum 15 to form an electrostatic latent image of each color.

Development device unit 30, housing development devices 20 of the invention, feeds the individual color toners onto photoreceptor drum 15 on which an electrostatic latent image is formed to perform development. Development device unit 30 is provided around shaft 33, around which four development devices 20Y, 20M, 20C and 20Bk which house nonmagnetic single-component yellow, magenta, cyan and black toners, respectively, and are rotated centering around shaft 33 so that each individual development device 20 is brought to the position opposite photoreceptor drum 15.

Development device unit 30 rotates on center shaft 33 for every electrostatic latent image formed of respective colors on photoreceptor drum 15 by laser scanning optical system 18, and guides development devices 20 housing a corresponding color toner to the position directly opposite photoreceptor drum 15. Thereby, the respective charged color toners are successively supplied from each of development devices 20Y, 20M, 20C and 20Bk onto photoreceptor drum 15 to perform development.

In the image forming apparatus shown in FIG. 3, endless intermediate belt 40 is provided downstream side in the rotation direction of photoreceptor drum 15 from development device unit 30 and the belt is rotated in synchronization with photoreceptor drum 15. Further, intermediate transfer belt 40 contacts photoreceptor 15 at the site being pressed by primary transfer roller 41, whereby the toner image formed on photoreceptor drum 15 is transferred onto intermediate transfer belt 40. Secondary rotating transfer roller 43 is provided in a rotatable manner opposite support roller 42 to support intermediate transfer belt 40, at which point the toner image carried on intermediate transfer belt 40 is transferred onto recording material S such as recording paper by being pressed at the site where support roller 42 and secondary roller 43 are opposed.

Between full-color developing unit 30 and intermediate transfer belt 40, cleaner 50 to remove any residual toner remaining on intermediate transfer belt 40 is provided with being detachable from intermediate transfer belt 40.

Paper feeding means 60 which guides recording material S onto intermediate transfer belt 40 is constituted of paper-feeding tray 61 housing recording material S, paper-feeding 62 to feed individual sheets of recording material S housed in paper-feeding tray 61 and timing roller 63 to transfer fed recording material S to the secondary transfer site.

Recording material S onto which a toner image has been transferred by being pressed is conveyed to fixing device 70 via conveyance means 66 constituted of an air-suction belt or the like, after which the transferred toner image is fixed on recording material S by fixing device 70. After fixing, recording material S is conveyed through vertical conveyance 80 and discharged onto the surface of apparatus body 100.

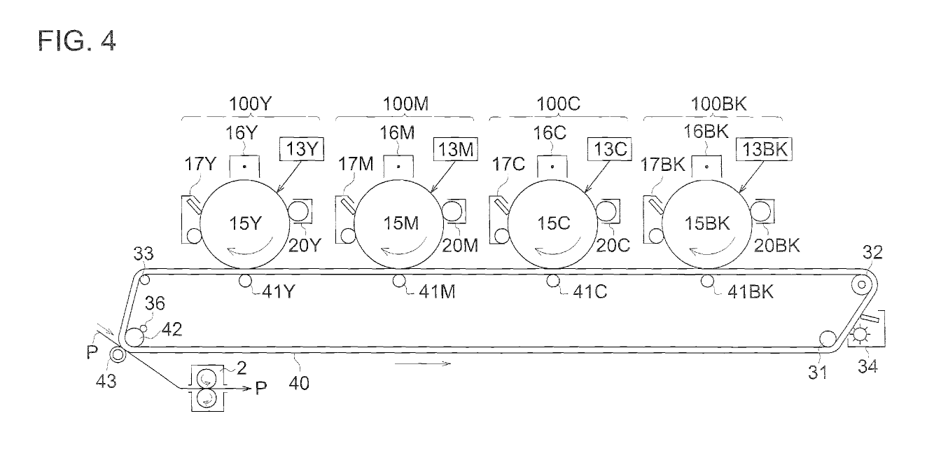

The toner according to the invention may also be loaded onto the so-called tandem type full-color image forming apparatus shown in FIG. 4 to perform image formation. The tandem type image forming apparatus shown in FIG. 4 is especially suitable for high speed image formation and is effective in, for example, on-demand rapid preparation of full-color prints.

The full-color image forming apparatus shown in FIG. 4 is composed of units 100Y, 100M, 100C and 100Bk, belt shape intermediate transfer body 40, transfer rollers 41Y, 41M, 41C and 41Bk, cleaning means 50 for intermediate transfer belt, and fixing device 70.

Units 100Y, 100M, 100C and 100Bk comprise photoreceptor drums 15Y, 15M, 15C and 15 Bk which are rotatable in the clockwise direction shown by an arrow at a predetermined circumferential speed (process speed). Around photoreceptor drums 15Y, 15M, 15C and 15 Bk are provided corotron chargers 16Y, 16M, 16C and 16Bk, exposure devices 18Y, 18M, 18C and 18Bk, development devices of each color (yellow development device 20Y, magenta development device 20M, cyan development device 20C and black development device 20Bk), and photoreceptor cleaners 17Y, 17M, 17C and 17Bk.

Four units 100Y, 100M, 100C and 100Bk are arranged in parallel to intermediate transfer belt 40, and the units can be arranged in an appropriate order corresponding to an image forming method, for example, in the order of 100Bk, 100Y, 100C and 100M.

Intermediate transfer belt 40 is constructed to be rotatable counterclockwise in the direction of the arrow at the same circumferential speed as photoreceptor drums 15Y, 15M, 15C and 15Bk by means of backup roller 42 and support rollers 31, 32 and 33. And intermediate transfer belt 40 is arranged so that the belt is in contact with photoreceptor drums 15Y, 15M, 15C and 15Bk at each position between support roller 32 and support roller 33.

Intermediate transfer belt 40 is provided with belt cleaning means 50. Support roller 31, which plays a role of a tension roller, is arranged movable in the planar direction of intermediate transfer belt 40, and then can adjust a tension of intermediate transfer belt 40.

Transfer rollers 41Y, 41M, 41C and 41Bk are disposed in the inside of intermediate transfer belt 40, and are disposed at each position opposing each contacting point of intermediate transfer belt 40 with each photoreceptor drum 15Y, 15M 15C and 15Bk. Transfer rollers 41 together with photoreceptor drums 15Y, 15M 15C and 15Bk form a primary transfer part (nip part) which transfer a toner image to intermediate transfer belt 40.

Bias roller 43 is disposed opposing backup roller 42 through intermediate transfer belt 40 on the upper surface of intermediate transfer belt 40 which bears a toner image. Bias roller 43 and backup roller 42 having intermediate transfer belt 40 therebetween form a secondary transfer part (nip part). Rotatable electrode roller 36 is disposed in pressure contact with backup roller 42.

Fixing device 70 is disposed so that transfer material S can be conveyed to the fixing device 70 after transfer material S passes the above secondary transfer part.

In unit 100Y of image forming apparatus shown in FIG. 4, photoreceptor drum 15Y is rotationally driven. In conjunction with the rotation, corotron charger 16Y operates to allow the surface of photoreceptor drum 15Y to be uniformly charged to predetermined polarity and potential.

Subsequent to the uniform charging on the surface of photoreceptor drum 15Y, an imagewise exposure is applied by exposure device 18Y to photoreceptor drum 15Y, resulting in formation of an electrostatic latent image thereon.

The latent image formed on photoreceptor drum 15Y is developed by yellow development apparatus 20Y, and to form a toner image on the surface of photoreceptor drum 15Y.

The toner image formed on the surface of photoreceptor drum 15Y is primary-transferred to an outer peripheral surface of intermediate transfer belt 40 at a primary transfer part (nip part) between photoreceptor drum 15Y and intermediate transfer belt 40 by the action of an electric field formed by a transfer bias applied by transfer roller 41Y.

After completion of the primary transfer onto intermediate transfer belt 40, any residual toner on photoreceptor drum 15Y is cleaned and removed by photoreceptor cleaning device 17Y. After the cleaning and removal are performed, photoreceptor drum 15Y is subjected to the subsequent transfer cycle.

The above transfer cycle is carried out in the same manner in units 100M, 100C and 100BK, whereby a second-color toner image, a third-color toner image and a fourth-color toner image are formed successively and are superposed on intermediate transfer belt 40, resulting in formation of a full-color toner image.

The full-color toner image transferred onto intermediate transfer belt 40 is conveyed to a secondary transfer part (nip part), where bias roller 43 is disposed, by a rotation of intermediate transfer belt 40.

Transfer material S is conveyed at a predetermined timing to a secondary transfer part which is between intermediate transfer belt 40 and bias roller 43. The toner image on intermediate transfer belt 40 is transferred to transfer material S by a pressure-contact conveyance by bias roller 43 and backup roller 42 and rotation of intermediate transfer belt 40.

Transfer material S on which a toner image is transferred is conveyed to fixing device 70, where the toner image is fixed by pressure/heating treatment. Intermediate transfer belt 40, whose secondary transfer is finished, is subjected to removal of any residual toner by cleaning means 50 for intermediate transfer belt which is disposed downstream of the secondary transfer part. After completion of the removal, intermediate transfer belt 40 is prepared for the subsequent transfer.

Transfer material S according to the invention is a support which is capable of bearing a toner image and is usually called an image support, a transfer material or a transfer paper. Examples of transfer material S are, but not limited to, a plain paper or a high-quality paper of various thickness, a coated printing paper such as an art paper and a coated paper, a commercial Japanese paper or a postcard, a plastic sheet for OHP use or cloth.

The embodiments of the invention will be described with reference to examples but the invention is by no means limited to these.

### 1. Preparation of Toners 1-13

Toners 1-13 were prepared according to the following steps.

### 1-1. Preparation of Resin Particle Dispersions A1-A4

### (1) Preparation of Resin Particle Dispersion A1

Into 3000 parts by mass of pure water in a reaction vessel was introduced 2 part by mass of sodium polyoxyethylene (2) dodecyl ether sulfate to prepare a surfactant solution (water-based medium).

Subsequently, compounds below were introduced into another reaction vessel to prepare a solution.

| | | |
|---|---|---|
| Styrene | 135 | parts by mass |
| n-Buthyl acrylate | 55 | parts by mass |
| Methylmethacrylate | 12 | parts by mass |
| n-Octhylmercaptane | 0.9 | parts by mass |

After the temperature of the solution was raised to 70° C., 100 parts by mass of pentaerythritol tetrabehenate, one of fatty acid esters, was added while stirring to the solution gradually to prepare a monomer solution.

After heating the above-described surfactant solution to 70° C. while stirring in a nitrogen gas atmosphere, the monomer solution incorporating the foregoing wax was added thereto, and the resulting solution was dispersed at 70° C. for 20 minutes employing a mechanical dispersion apparatus “CLEARMIX (produced by M-TECHNIQUE Co., Ltd.)” having a circulation path, to result in an emulsified dispersion.

A reaction vessel into which the aforesaid emulsified dispersion was introduced was provided with a mixer, a thermometer, a condenser and a nitrogen-introducing tube, and then, the vessel was heated to 80° C. while stirring in a nitrogen gas atmosphere.

Subsequently, 45 parts by mass of aqueous 5% potassium persulfate solution was introduced into the above emulsified dispersion, followed by a polymerization reaction in 3 hours (a first-step polymerization). Further added to the reacted solution was 120 parts by mass of aqueous 5% potassium persulfate solution, and a mixed solution of compounds below was dropwise added thereto in 2 hours. Then, polymerization was further carried out in 2 hours (a second-step polymerization).

| | | |
|---|---|---|
| Styrene | 342 | parts by mass |
| n-Buthyl acrylate | 125 | parts by mass |
| Methylmethacrylate | 27 | parts by mass |
| n-Octhylmercaptane | 6.5 | parts by mass |

Resin particle dispersion A1 (resin particle A1) was prepared according to the foregoing procedure. A volume average particle diameter of the resin particle A1 was 150 nm, determined by employing the above-mentioned dynamic light scattering type NANOTRACK particle size distribution meter “MICROTRACK UPA150” (produced by Microtrack Co.).

### (2) Preparation of Resin Particle Dispersion A2

Resin particle dispersion A2 (resin particle A2) was prepared in the same manner as in resin particle dispersion A1 except that additive amounts of pentaerythritol tetrabehenate and n-octhylmercaptane in the monomer solution employed in the first-step polymerization for the preparation of the resin particle dispersion A1 were changed to 110 parts by mass and 0.85 parts by mass respectively, the dispersion was carried out at 70° C. for 15 minutes for the preparation of the emulsified dispersion, additive amount of aqueous 5% potassium persulfate solution was changed to 60 parts by mass, and additive amounts of n-octhylmercaptane and aqueous 5% potassium persulfate solution out of compounds employed in the second-step polymerization were changed to 8.4 parts by mass and 130 parts by mass respectively. A volume average particle diameter of the resin particle A2 was 200 nm.

### (3) Preparation of Resin Particle Dispersion A3

Additive amounts of aqueous 5% potassium persulfate solution and n-octhylmercaptane, which were employed in the first-step polymerization for the preparation of the resin particle dispersion A1, were changed to 50 parts by mass and 0.85 parts by mass, respectively. In addition, additive amounts of compounds employed in the second-step polymerization were changed to below.

| | | |
|---|---|---|
| Styrene | 239 | parts by mass |
| n-Buthyl acrylate | 87 | parts by mass |
| Methylmethacrylate | 19 | parts by mass |
| n-Octhylmercaptane | 4.5 | parts by mass |

Further, dropping time of the mixed solution of the above compounds and polymerization time after the dropping were changed to 1.7 hours and 1.7 hours respectively. In addition, additive amount of aqueous 5% potassium persulfate solution was changed to 130 parts by mass. Then, except for the above changes, resin particle dispersion A3 (resin particle A3) was prepared in the same manner as in resin particle dispersion A1. A volume average particle diameter of the resin particle A3 was 100 nm.

### (4) Preparation of Resin Particle Dispersion A4

Additive amounts of compounds employed in the first-step polymerization for the preparation of resin particle A1, were changed to below.

| | | |
|---|---|---|
| Styrene | 169 | parts by mass |
| n-Buthyl acrylate | 69 | parts by mass |
| Methylmethacrylate | 15 | parts by mass |
| n-Octhylmercaptane | 1.2 | parts by mass |

In addition, additive amount of pentaerythritol tetrabehenate was changed to 130 parts by mass, and the dispersion was carried out at 70° C. for 10 minutes for the preparation of the emulsified dispersion. Further, the time of the polymerization reaction which was conducted after the addition of aqueous 5% potassium persulfate solution was changed to 3.5 hours.

Subsequently, additive amounts of the compounds employed in the second-step polymerization were changed to below.

| | | |
|---|---|---|
| Styrene | 427 | parts by mass |
| n-Buthyl acrylate | 155 | parts by mass |
| Methylmethacrylate | 33 | parts by mass |
| n-Octhylmercaptane | 6 | parts by mass |

In addition, dropping time of the mixed solution of the above compounds and polymerization time after the dropping were changed to 2.8 hours and 2.8 hours, respectively. Then, except for the above changes, resin particle dispersion A4 (resin particle A4) was prepared in the same manner as in resin particle dispersion A1. A volume average particle diameter of the resin particle A4 was 300 nm.

### 1-2. Preparation of Resin Particle Dispersions B1-B4

### (1) Preparation of Resin Particle Dispersions B1

To a reaction vessel provided with a mixer, a thermometer, a condenser and a nitrogen-introducing tube were added 3000 parts by mass of pure water and 2.5 parts by mass of sodium dodecylsulfate (SDS). After that, the vessel was heated to 80° C. to prepare a surfactant solution. Subsequently, 162 parts by mass of aqueous 5% potassium persulfate solution was added to the above surfactant solution, and then a mixed solution composed of the following compounds such as polymerizable monomers was dropwise added to the above surfactant solution in two hours, followed by polymerization reaction in a nitrogen gas atmosphere for two hours.

| | | |
|---|---|---|
| Styrene | 565 | parts by mass |
| n-Buthyl acrylate | 175 | parts by mass |
| Methylmethacrylate | 75 | parts by mass |
| n-Octhylmercaptane | 6 | parts by mass |

After the polymerization reaction, the resulting solution was cooled down to prepare resin particle dispersion B1 (resin particle B1). A volume average particle diameter of the resin particle B1, measured by employing the above-mentioned dynamic light scattering type NANOTRACK particle size distribution meter, was 80 nm. In addition, a weight average molecular weight was 25,000, measured via a gel permeation chromatography employing the above-mentioned HLC-8220 (produced by Tosoh Corp.).

### (2) Preparation of Resin Particle Dispersion B2

Resin particle dispersion B2 (resin particle B2) was prepared in the same manner as the preparation of the resin particle dispersion B1 except that the additive amount of sodium dodecylsulfate (SDS) was changed to 10 parts by mass, and the additive amounts of compounds were changed as below.

| | | |
|---|---|---|
| Styrene | 55 | parts by mass |
| n-Buthyl acrylate | 17 | parts by mass |
| Methylmethacrylate | 7 | parts by mass |
| n-Octhylmercaptane | 0.6 | parts by mass |

The volume average particle diameter and the weight average molecular weight of the resulting resin particle B2 was 7.5 nm and 20,000, respectively.

### (3) Preparation of Resin Particle Dispersion B3

Resin particle dispersion B3 (resin particle B3) was prepared in the same manner as the preparation of the resin particle dispersion B1 except that the additive amount of aqueous 5% potassium persulfate solution was changed to 90 parts by mass, and the additive amounts of compounds were changed as below.

| | | |
|---|---|---|
| Styrene | 595 | parts by mass |
| n-Buthyl acrylate | 175 | parts by mass |
| Methylmethacrylate | 45 | parts by mass |
| n-Octhylmercaptane | 1.5 | parts by mass |

The volume average particle diameter and the weight average molecular weight of the resulting resin particle B3 was 105 nm and 200,000, respectively.

### (4) Preparation of Resin Particle Dispersion B4

One part by mass of sodium polyoxyethylene (2) dodecyl ether sulfate was employed in place of 3 parts by mass of sodium dodecylsulfate employed for the preparation of surfactant solution in the preparation of the resin particle dispersion B1. Then, except for the above change, resin particle dispersion B4 (resin particle B4) was prepared in the same manner as the preparation of the resin particle dispersion B1. The volume average particle diameter and the weight average molecular weight of the obtained resin particle B4 was 210 nm and 50,000, respectively.

### 1-3. Preparation of Resin Particle Dispersion C

To a reaction vessel provided with a mixer, a temperature sensor, a cooling tube and a nitrogen-introducing tube were added 2 parts by mass of sodium dodecylsulfate (SDS) and 3000 parts by mass of deionized water, and then, the solution was heated to 80° C. while stirring to prepare a surfactant aqueous solution.

To the above surfactant solution was added 40 parts by mass of aqueous 5% potassium persulfate solution, while prepared was a mixed solution of polymerizable monomers incorporating compounds below, which was added to the above surfactant solution, followed by a polymerization reaction at 80° C. in 120 minutes in a nitrogen gas atmosphere.

| | | |
|---|---|---|
| Styrene | 616 | parts by mass |
| n-Buthyl acrylate | 160 | parts by mass |
| Methylmethacrylate | 24 | parts by mass |
| n-Octhylmercaptane | 8 | parts by mass |

After the completion of the polymerization reaction, the solution was cooled down to 40° C., resulting in preparation of resin particle dispersion C for shelling use.

### 1-4. Preparation of Coloring Agent Dispersion 1

To a reaction vessel were added 1000 parts by mass of pure water and 85 parts by mass of sodium dodecylsulfate to prepare a surfactant solution. Then, to the surfactant solution added gradually while starring was 375 parts by mass of C.I. Pigment Blue 15:3 (copper phthalocyanine type cyan pigment) having a percentage of water content of 50% to prepare coloring agent preliminary dispersion. The coloring agent preliminary dispersion was subjected to a dispersion treatment for two hours employing a homogenizer to prepare coloring agent dispersion 1.

### 1-5. Preparation of Colored Particles 1-13

### (1) Preparation of Colored Particle 1

To a reaction vessel provided with a mixer, a thermometer and a condenser were added 2010 parts by mass of pure water and 2 parts by mass of sodium polyoxyethylene (2) dodecyl ether sulfate to prepare a surfactant solution. To the surfactant solution, dispersions below were introduced, and the resultant solution was stirred to prepare a reacted solution.

| | |
|---|---|
| Resin particle dispersion A1 | 214 parts by mass |
| | (equivalent converted to solids) |
| Resin particle dispersion B1 | 24 parts by mass |
| | (equivalent converted to solids) |
| Coloring agent dispersion 1 | 16 parts by mass |
| | (equivalent converted to solids) |

After the temperature of the above reacted solution was regulated to 30° C., the pH thereof was regulated to 10.0 by addition of 5 molar/liter sodium hydroxide aqueous solution.

Subsequently, 100 parts by mass of 50% aqueous solution of magnesium chloride was added to the above solution while stirring at 30° C. in 10 minutes. After three minutes had passed since completion of the addition, the reacting solution was heated to 95° C. in 60 minutes to promote coagulation of the above resin particles, the component to enhance coagulation and coloring agent. The coagulated particle size was observed via MULTISIZER 3 (produced by Beckman Coulter, Inc.)

When a volume-based median diameter of the coagulated particles reached 6.0 μm, the dispersion below was dropwise added to the above solution in 20 minutes, whereby the aforesaid particle surface was subjected to a shelling treatment.

| | |
|---|---|
| Resin particle dispersion C | 70 parts by mass |
| | (equivalent converted to solids) |

After the addition of the resin particle dispersion C, a sample of the above solution was subjected to centrifugation, and then allowed to stand for 90 minutes until supernatant fluid became clear.

After the termination of the shelling, an aqueous solution of 115 parts by mass of sodium chloride dissolved in 700 parts by mass of deionized water was added to terminate the coagulation.

Then, the temperature of the solution was regulated to 90° C.±2° C., while the solution being heated and stirred, whereby, the average circularity of the particles was regulated. Further, the solution was continuously heated and stirred until reached an average circularity of 0.950 measured by employing FPIA-2100 (produced by Sysmex Co.). Subsequently, the solution was cooled down to 30° C., and the pH of the solution was adjusted to 2.0 with hydrochloric acid, and then, the stirring was terminated, whereby a colored particle dispersion was prepared.

The prepared colored particle dispersion was separated into a solid and a liquid, and the solid was washed with deionized water four times (each amount of the ionized water used was 15 litters). Thereafter, the solid was dried in the wind of a warm air of 40° C. to prepare colored particle 1.

The volume-based median diameter of the formed colored particle 1 was 6.5 μm measured via MULTISIZER 3 (produced by Beckman Coulter, Inc.). The softening point was 110° C. measured via “FLOW TESTER CFT-500” (produced by Shimadzu Corp.)

### (2) Preparation of Colored Particle 2

Colored particle 2 was prepared in the same manner as the preparation of the colored particle 1 except that additive amounts of resin particle dispersion A1 and resin particle dispersion B1 were changed to amounts below.

| | |
|---|---|
| Resin particle dispersion A1 | 190 parts by mass |
| | (equivalent converted to solids) |
| Resin particle dispersion B1 | 48 parts by mass |
| | (equivalent converted to solids) |

The volume-based median diameter, the average circularity and the softening point of colored particle 2 were the same as those of colored particle 1.

### (3) Preparation of Colored Particle 3

Colored particle 3 was prepared in the same manner as the preparation of the colored particle 1 except that additive amounts of resin particle dispersion A1 and resin particle dispersion B1 were changed to amounts below.

| | |
|---|---|
| Resin particle dispersion A1 | 226 parts by mass |
| | (equivalent converted to solids) |
| Resin particle dispersion B1 | 12 parts by mass |
| | (equivalent converted to solids) |

The volume-based median diameter, the average circularity and the softening point of colored particle 3 were the same as those of colored particle 1.

### (4) Preparation of Colored Particle 4

Colored particle 4 was prepared in the same manner as the preparation of the colored particle 1 except that additive amounts of resin particle dispersion B1 was changed to those of resin particle dispersion B2. The volume-based median diameter and the average circularity were the same as those of colored particle 1, but the softening point of colored particle 4 was 106° C.

### (5) Preparation of Colored Particle 5

Colored particle 5 was prepared in the same manner as the preparation of the colored particle 1 except that additive amounts of resin particle dispersion B1 was changed to those of resin particle dispersion B3. The volume-based median diameter and the average circularity were the same as those of colored particle 1, but the softening point of colored particle 4 was 117° C.

### (6) Preparation of Colored Particle 6

Colored particle 6 was prepared in the same manner as the preparation of the colored particle 1 except that additive amounts of resin particle dispersion A1 was changed to those of resin particle dispersion A2. The volume-based median diameter and the average circularity were the same as those of colored particle 1, but the softening point of colored particle 4 was 114° C.

### (7) Preparation of Colored Particle 7

Colored particle 7 was prepared in the same manner as the preparation of the colored particle 1 except that additive amounts of resin particle dispersion A1 and resin particle dispersion B1 were changed to those of resin particle dispersion A3 and resin particle dispersion B2, respectively. The volume-based median diameter and the softening point of colored particle 7 were 6.2 μm and 106° C., respectively, and the average circularity was the same as that of colored particle 1.

### (8) Preparation of Colored Particle 8

Colored particle 8 was prepared in the same manner as the preparation of the colored particle 1 except that additive amounts of resin particle dispersion A1 and resin particle dispersion B1 were changed to those of resin particle dispersion A4 and resin particle dispersion B4, respectively. The volume-based median diameter and the softening point of colored particle 8 were 6.8 μm and 109° C., respectively, and the average circularity was the same as that of colored particle 1.

### (9) Preparation of Colored Particle 9

Colored particle 9 was prepared in the same manner as the preparation of the colored particle 1 except that additive amounts of resin particle dispersion A1 and resin particle dispersion B1 were changed to those of resin particle dispersion A2 and resin particle dispersion B2, respectively. The volume-based median diameter and the average circularity of colored particle 9 were the same as those of colored particle 1, and the softening point was 104° C.

### (10) Preparation of Colored Particle 10

Colored particle 10 was prepared in the same manner as the preparation of the colored particle 1 except that additive amounts of resin particle dispersion A1 was changed to those of resin particle dispersion A3. The volume-based median diameter and the softening point of colored particle 10 were the same as those of colored particle 1, and the average circularity was 0.928.

### (11) Preparation of Colored Particle 11

Colored particle 11 was prepared in the same manner as the preparation of the colored particle 1 except that additive amounts of resin particle dispersion A1 and resin particle dispersion B1 were changed to those of resin particle dispersion A3 and resin particle dispersion B3, respectively. The volume-based median diameter, the average circularity and the softening point of colored particle 11 were 6.7 μm, 0.919 and 117° C., respectively.

### (12) Preparation of Colored Particle 12

Colored particle 12 was prepared in the same manner as the preparation of the colored particle 1 except that additive amounts of resin particle dispersion A1 and resin particle dispersion B1 were changed to those of resin particle dispersion A4 and resin particle dispersion B2, respectively. The volume-based median diameter, the average circularity and the softening point of colored particle 12 were 6.3 μm, 0.919 and 117° C. respectively.

### (13) Preparation of Colored Particle 13

Colored particle 13 was prepared in the same manner as the preparation of the colored particle 1 except that a core particle was formed employing 1190 parts by mass of resin particle dispersion A1 without employing resin particle dispersion B1. The volume-based median diameter and the average circularity of colored particle 13 were the same as those of colored particle 1, and the softening point was 105° C.

Colored particles 1-13 were prepared with the above-mentioned procedure.

### 1-6. Preparation of Toners 1-13

To the above colored particles 1-13 were added external additives such as 0.8 parts by mass of hydrophobic silica having a number-average primary particle size of 12 nm and a degree of hydrophobicity of 65, and 0.5 parts by mass of hydrophobic titania having a number-average primary particle size of 30 nm and a degree of hydrophobicity of 55, followed by a mixing treatment via a Henschel mixer. Thereby, toners 1-13 for use in image formation via a nonmagnetic mono-component developing system were prepared.

In Table 1 are described items such as conditions to prepare the above-described toners 1-13.

TABLE 1

| | Resin particle A | | Resin particle B | | |
|---|---|---|---|---|---|
| | | Particle | | Particle | Diameter |
| Toner | | diameter Dₐ | | diameter D_{b} | ratio |
| No. | Types | (nm) | Types | (nm) | D_{b}/Dₐ |
| 1 | A1 | 150 | B1 | 80 | 0.53 |
| 2 | A1 | 150 | B1 | 80 | 0.53 |
| 3 | A1 | 150 | B1 | 80 | 0.53 |
| 4 | A1 | 150 | B2 | 7.5 | 0.05 |
| 5 | A1 | 150 | B3 | 105 | 0.70 |
| 6 | A2 | 200 | B1 | 80 | 0.40 |
| 7 | A3 | 100 | B2 | 7.5 | 0.08 |
| 8 | A4 | 300 | B4 | 200 | 0.67 |
| 9 | A2 | 200 | B2 | 7.5 | 0.04 |
| 10 | A3 | 100 | B1 | 80 | 0.80 |
| 11 | A3 | 100 | B3 | 105 | 1.05 |
| 12 | A4 | 300 | B2 | 7.5 | 0.03 |
| 13 | A1 | 150 | — | — | — |

### 2. Evaluation

The following evaluation was conducted using a full-color printer which mounted a development device for cyan color incorporating the aforesaid toners 1-13. Test samples corresponding to the invention are denoted as Examples 1-8, and test samples not corresponding to the invention are denoted as Comparative Examples 1-5.

Evaluation was conducted using a full-color printer of a nonmagnetic mono-component developing system, Magicolor 2300DL (produced by Konica Minolta Business Technology Inc.) which mounted a development device for cyan color incorporating the aforesaid toners 1-13, under an environment of ordinary temperature and humidity (20° C., 55% RH). Test samples using toners 1-8 and toners 9-13 are denoted as Example 1-8 and Comparative Examples 1-5, respectively.

Specifically, the evaluation was conducted according to the procedure described below. First, ten A4 sheets were printed successively as samples to evaluate a quality of an initial cyan toner image. Subsequently, ten thousand A4 sheets were printed successively with a condition that the above full-color printer did not consume cyan toner. During the printing, the cyan toner housed in the cyan color development device remained under an environment where the toner was stressed of agitation. After the above successive printing of ten thousand sheets, ten A4 sheets were printed continuously as samples to evaluate a cyan toner image quality after the toner was subjected to the agitation. Thus, samples were prepared for quality evaluation of cyan toner images employing a cyan toner of both initial printing and after successive ten thousand sheets printing. In a series of printing, outputted were original images of a pixel ratio of 5% (an A4 size original image composed of four equal parts of a fine-line image, a halftone image, a white background image and a solid black image).

After the preparation of the samples for image quality evaluation, the cyan color development device was taken out from the above-mentioned full-color printer, and evaluations were conducted about a level of toner scattering at the surroundings of the development device as well as generation of filming on a surface of the development roller. Further, the taken out cyan color development device was allowed to stand for 50 days under an environment of ordinary temperature and humidity (20° C., 55% RH), and a packing property was evaluated at 25th and 50th days from the date when the test started.

### (2) Evaluation Items

For the image quality evaluation, the outputted prints of the initial printing and after the successive ten thousand printing were employed with regard to evaluation items of density unevenness, fog, reproduction of fine-lines and uneven distribution/drop out. Employed for the evaluation were five sample prints which were outputted from 5th to 9th printing for each initial printing and after the successive printing, whereby average data thereof were used as the evaluation results.

### <Density Unevenness>

Reflection densities at ten points on the outputted solid black print were randomly measured via Macbeth Reflection Densitometer (RD-918), and the density unevenness was evaluated by a density difference between maximum and minimum densities of the solid black print. Evaluated acceptable were prints whose density difference between maximum and minimum densities of the solid black print which was made at the successive ten thousand printings was less than 0.10.

### <Fog>

Fog was evaluated by measuring reflection densities at white background of the print image made after successive ten thousand printings. Prints of the densities being less than 0.01 were evaluated to be acceptable in practice. Reflection density measurement at the white parts was conducted via Reflection Densitometer RD-918 (produced by Macbeth Co.)

### <Reproduction of Fine-Lines>

Fine-line image was magnified using a ten-power loupe, and a number of fine-lines per one mm which were clearly visible was visually counted. Specifically, the fine-line image in the above original image is composed of three types of fine-line images of 4 lines/mm, 5 lines/mm and 6 lines/mm, and the line type in which light brush-stroke or thickened were generated was evaluated not-acceptable as an inferior line image. An original image having non-inferior line image at least 5 lines/mm was evaluated to be acceptable in practice.

### <Density Uniformity>

Employing both a solid black image and a halftone image, it was visually evaluated whether there exists or not a decreased density part (drop out) or an increased density part (uneven distribution) on the front end or the rear end in the direction of paper conveyance. Critical samples were employed for the evaluation.

It was evaluated to be acceptable in practice (A) in cases when neither drop out nor uneven distribution existed, and evaluated unacceptable (Un-A) when either drop out or uneven distribution existed.

Evaluations of the toner scattering and the filming were conducted after preparation of the image quality samples after the successive ten thousand printing were carried out. The evaluations were carried out as described below.

### <Toner Scattering>

By visual observation of the surroundings of the development device of the full-color printer, a level of toner scattering was evaluated as below. The levels A and B were evaluated to be acceptable in practice.

Level A: No toner scattering was observed.

Level B: Toner scattering was slightly observed but was acceptable in practice.

Level C: Staining of the interior of the devices was observed and unacceptable in practice.

### <Filming>

By visual observation of generation of a filming on a surface of a development roller incorporated in a developing apparatus and the above-mentioned print image, a level of generation of filming was evaluated as below. The levels A and B were evaluated to be acceptable in practice.

Level A: No filming was observed.

Level B: Filming was slightly observed but no inferior image appeared in a print image, which was acceptable in practice.

Level C: Filming was definitely observed and an inferior image appeared in a print image, which was unacceptable in practice.

Further, a storage stability of a toner which was kept standing was evaluated as described below (evaluation of a packing phenomenon).

A storage stability (a packing phenomenon) of a toner which was kept standing was evaluated by observing a state of cyan color developing agent when it was taken out from the above-mentioned each toner cartridge which was kept standing still. Keeping a toner gate downward, a toner discharging from the toner gate was evaluated, and simultaneously, 20 ml of discharged toner was taken, which was visually observed with respect to toner lump. Levels of evaluation are described below. Levels A, B and C were evaluated to be acceptable in practice.

### Evaluation Levels

Level A: When discharging a toner which was stored for 50 days, there was no feeling that the toner was caught at a toner gate. Further, no toner lump was observed. There was no problem in toner discharging.

Level B: When discharging a toner which was stored for 25 days, there was no feeling that the toner was caught at a toner gate. Further, no toner lump was observed. In addition, when discharging a toner which was stored for 50 days, there was a slight feeling that the toner was caught at a toner gate, but no toner lump was observed, and a toner was smoothly discharged.

Level C: When discharging a toner which was stored for 25 days, a toner was allowed to be discharged even though torque was exerted on a stirring part. In addition, no toner lump was observed. There was no problem in toner discharging.

Level D: When discharging a toner which was stored for 25 days, a toner was not allowed to be discharged due to torque was exerted on a stirring part. Otherwise, a lump of a toner was observed even though a toner was allowed to be discharged.

The results are given in Table 2.

TABLE 2

| | | Density | | | Reproduction | | Density | | | | |
|---|---|---|---|---|---|---|---|---|---|---|---|
| | | unevenness | | | of fine-line | | uniformity | | | | |
| | | | Print | | | Print | | Print | | | |
| | | | after ten | | | after ten | | after ten | | | |
| | Toner | Initial | thousand | | Initial | thousand | Initial | thousand | Toner | | Storage |
| | No. | print | printing | Fog | print | printing | print | printing | scattering | Filming | stability |
| Example 1 | 1 | 0.02 | 0.04 | 0.003 | 6 | 6 | A | A | A | A | A |
| Example 2 | 2 | 0.01 | 0.02 | 0.002 | 6 | 6 | A | A | A | A | A |
| Example 3 | 3 | 0.03 | 0.06 | 0.006 | 6 | 5 | A | A | B | B | A |
| Example 4 | 4 | 0.05 | 0.07 | 0.007 | 5 | 5 | A | A | B | B | B |
| Example 5 | 5 | 0.04 | 0.07 | 0.008 | 5 | 5 | A | A | B | B | B |
| Example 6 | 6 | 0.01 | 0.03 | 0.002 | 6 | 6 | A | A | A | A | A |
| Example 7 | 7 | 0.02 | 0.04 | 0.003 | 6 | 6 | A | A | A | A | A |
| Example 8 | 8 | 0.06 | 0.08 | 0.007 | 5 | 5 | A | A | B | B | C |
| Comp. 1 | 9 | 0.06 | 0.10 | 0.011 | 5 | 5 | A | Un-A | B | B | C |
| Comp. 2 | 10 | 0.07 | 0.11 | 0.011 | 5 | 4 | A | A | B | B | C |
| Comp. 3 | 11 | 0.08 | 0.15 | 0.018 | 5 | No good | A | Un-A | C | C | D |
| | | | | | | image | | | | | |
| | | | | | | print | | | | | |
| Comp. 4 | 12 | 0.09 | 0.14 | 0.017 | 5 | No good | A | Un-A | C | C | D |
| | | | | | | image | | | | | |
| | | | | | | print | | | | | |
| Comp. 5 | 13 | 0.07 | 0.13 | 0.015 | 4 | 4 | Un-A | Un-A | C | C | C |

Comp.: Comparative Example

As shown in Table 2, it was proved that Examples 1-8 which satisfy constitutions of the present invention attained superior results with respect to the foregoing evaluation items. On the other hand, Comparative Examples 1-5 which do not satisfy constitutions of the present invention were not evaluated to be acceptable in practice in at least one of evaluation items, and it was proved that Comparative Examples do not achieve advantageous effect of the present invention.

What is claimed is:

1. A toner for developing electrostatic image comprising toner particles prepared with a method containing a step of:
coagulating resin particle A, resin particle B and a colorant,
wherein resin particle A and resin particle B respectively have volume average particle diameters Dₐ and D_{b} which are different in value from each other; and
Dₐ and D_{b} satisfy the following relationship:
0.05≦D_{b}/Dₐ≦0.7.

2. The toner of claim 1,
wherein the volume average particle diameter D_{b} of resin particle B is from 7.5 to 200 nm, and a weight average molecular weight of resin particle B is from 20,000 to 200,000 measured with gel permeation chromatography.

3. A method of forming a toner for developing electrostatic image comprising a step of:
coagulating resin particle A, resin particle B and the colorant,
wherein resin particle A and resin particle B respectively have volume average particle diameters Dₐ and D_{b} which are different in value from each other; and
Dₐ and D_{b} satisfy the following relationship:
0.05≦D_{b}/Dₐ≦0.7.

4. The method of forming a toner for developing electrostatic image of claim 3,
wherein the volume average particle diameter D_{b} of resin particle B is from 7.5 to 200 nm, and a weight average molecular weight of resin particle B is from 20,000 to 200,000 measured with gel permeation chromatography.
